(19) United States
(12) Patent Application Publication
(10) Pub. No.: US 2026/0194193 A1
(43) Pub. Date: Jul. 9, 2026

(54) LIGHTING FIXTURES HAVING A ROTATABLE ILLUMINABLE ASSEMBLY AND METHODS FOR PROVIDING ILLUMINATION

(71) Applicant: Wangs Alliance Corporation, Port Washington, NY (US)

(72) Inventors: Emanuel VALERA REYES, Crestline, CA (US); Aaron JOHNSON, Austin, TX (US)

(73) Assignee: Wangs Alliance Corporation, Port Washington, NY (US)

(21) Appl. No.: 19/439,907

(22) Filed: Jan. 5, 2026

Related U.S. Application Data
(60) Provisional application No. 63/742,655, filed on Jan. 7, 2025.

(51) Int. Cl. F21K 9/65; F21K 9/275; F21Y 103/10; F21Y 115/10

(52) U.S. Cl. CPC F21K 9/65; F21K 9/275; F21Y 2103/10; F21Y 2115/10

(57) ABSTRACT

A lighting fixture and methods for providing illumination are provided. The lighting fixture may include a frame and a first illuminable assembly rotatably supportable by the frame. The first illuminable assembly may include a first end, a second end, and first axis extending from the first end to the second end, a first portion extending from the first end of the first illuminable assembly to the second end of the first illuminable assembly, a second portion extending from the first end of the first illuminable assembly to the second end of the of the first illuminable assembly, the first portion being different from the second portion, and a light source disposable between the first portion and the second portion.

### CROSS-REFERENCE TO RELATED APPLICATIONS

This application is a U.S. Non-Provisional Application which claims priority to U.S. Provisional Application No. 63/742,655 filed Jan. 7, 2025, by Emanuel Valera Reyes and Aaron Johnson, entitled “LIGHTING FIXTURES HAVING A ROTATABLE ILLUMINABLE ASSEMBLY AND METHODS FOR PROVIDING ILLUMINATION” (attorney docket no. 6033.369P1, which is related to commonly assigned U.S. Design Patent Application No. 29/980,138, filed on Dec. 23, 2024, by Emanuel Valera Reyes and Aaron Johnson, entitled “LIGHTING FIXTURE” (attorney docket no. 6033.368), which are incorporated herein by reference in their entirety.

### FIELD

The present disclosure relates generally to lighting fixtures and methods for providing illumination.

### BACKGROUND

Recently, light emitting diode (LED) lighting fixtures are becoming more popular. One such LED fixture generally includes a LED module having a plurality of LEDs attached thereto for directing light inwardly toward an edge of an optical panel or light guide.

### SUMMARY

In a first aspect, the present disclosure provides a lighting fixture including a frame and a first illuminable assembly rotatably supportable by the frame. The first illuminable assembly has a first end, a second end, and a first axis extending from the first end to the second end. The first illuminable assembly includes a first portion extending from the first end of the first illuminable assembly to the second end of the first illuminable assembly, and a second portion extending from the first end of the first illuminable assembly to the second end of the of the first illuminable assembly. The first portion may be different from the second portion. The first illuminable assembly includes a light source disposable between the first portion and the second portion. The first illuminable assembly is rotatable about the first axis between a first orientation of the first portion and the second portion, and a second orientation of the first portion and the second portion, wherein the second orientation is different from the first orientation of the first portion and the second portion.

In a second aspect, the present disclosure provides a method for providing illumination. The method includes emitting light from a light source of an illuminable assembly in a first direction, the illuminable assembly defining an axis and disposed in a first orientation and having a first portion and a second portion. The light being emitted from the first portion is different from the light being emitted from the second portion. The method includes rotating the illuminable assembly about the axis of the illuminable assembly from the first orientation to a second orientation, the second orientation being different from the first orientation, and emitting light from the light source of the illuminable assembly in the second orientation.

### BRIEF DESCRIPTION OF THE DRAWINGS

The subject matter which is regarded as the disclosure is particularly pointed out and distinctly claimed in the concluding portion of the specification. The disclosure, however, may be better understood when the following detailed description is read with reference to the accompanying drawings, wherein:

FIG. 1 is a front right perspective view from above of one embodiment of a lighting fixture in accordance with an aspect of the present disclosure;

FIG. 2 is a rear right perspective view from above of the lighting fixture of FIG. 1;

FIG. 3 is a front right perspective view from below of the lighting fixture of FIG. 1;

FIG. 4 is a front left perspective view from below of the lighting fixture of FIG. 1;

FIG. 5 is a rear left perspective view from below of the lighting fixture of FIG. 1;

FIG. 6 is a right side elevational view of the lighting fixture of FIG. 1;

FIG. 7 is a left side elevational view of the lighting fixture of FIG. 1;

FIG. 8 is a top plan view of the lighting fixture of FIG. 1;

FIG. 9 is a bottom plan view of the lighting fixture of FIG. 1;

FIG. 10 is a front side elevational view of the lighting fixture of FIG. 1;

FIG. 11 is a rear side elevational view of the lighting fixture of FIG. 1;

FIG. 12 is a cross-sectional view through a pair of the illuminable assemblies of the lighting fixture of FIG. 1;

FIG. 13 is a cross-sectional view through a support bracket of the lighting fixture of FIG. 1;

FIG. 14 is a cross-sectional view through a set of illuminable assemblies of the lighting fixture of FIG. 1;

FIG. 15 is a cross-sectional view through a bracing element of the lighting fixture of FIG. 1; and

FIG. 16 is a front right perspective view from above of one embodiment of a lighting fixture in accordance with an aspect of the present disclosure, portions of which rotated;

FIG. 17 is a front right perspective view from above of one embodiment of a lighting fixture in accordance with an aspect of the present disclosure, portions of which rotated;

FIG. 18 is a front right perspective view from above of one embodiment of a lighting fixture in accordance with an aspect of the present disclosure, portions of which rotated;

FIG. 19 is a front right perspective view from above of one embodiment of a lighting fixture in accordance with an aspect of the present disclosure, portions of which rotated;

FIG. 20 is a front right perspective view from above of one embodiment of a lighting fixture in accordance with an aspect of the present disclosure, portions of which rotated;

FIG. 21 is a front right perspective view from above of one embodiment of a lighting fixture in accordance with an aspect of the present disclosure, portions of which rotated;

FIG. 22 is a front right perspective view from above of one embodiment of a lighting fixture in accordance with an aspect of the present disclosure, portions of which rotated;

FIG. 23 is a front right perspective view from above of one embodiment of a lighting fixture in accordance with an aspect of the present disclosure, portions of which rotated;

FIG. 24 is a flowchart illustrating a method for providing illumination in accordance with an aspect of the present disclosure;

FIG. 25 is a rear right perspective view from above of an example support bracket of the lighting fixture of FIG. 1;

FIG. 26 is a front left perspective view from below of the support bracket of FIG. 25;

FIG. 27 is an exploded view of the support bracket of FIG. 25;

FIG. 28 is a rear right perspective view from above of an example support bracket of the lighting fixture of FIG. 1;

FIG. 29 is a front left perspective view from below of the support bracket of FIG. 28;

FIG. 30 is an exploded view of the support bracket of FIG. 28;

FIG. 31 is a perspective view of an example illuminable assembly of the lighting fixture of FIG. 1;

FIG. 32 is an exploded view of the illuminable assembly of FIG. 31;

FIG. 33 is an exploded view of the illuminable assembly of FIG. 31;

FIG. 34 is an exploded view of the illuminable assembly of FIG. 31;

FIG. 35 is a perspective view of the illuminable assembly of FIG. 31;

FIG. 36 is a perspective view of the illuminable assembly of FIG. 31; and

FIG. 37 is a perspective view of an example first portion of the illuminable assembly of FIG. 31.

### DETAILED DESCRIPTION

In some embodiments, lighting fixtures of the present disclosure may include LED fixtures that can be modified with opaque materials to change the shape of light emitted or orient the direction at which light is emitted from a fixture. In some embodiments, translucent and opaque materials may be configured to rotate to allow for different configurations and orientations of emitted light.

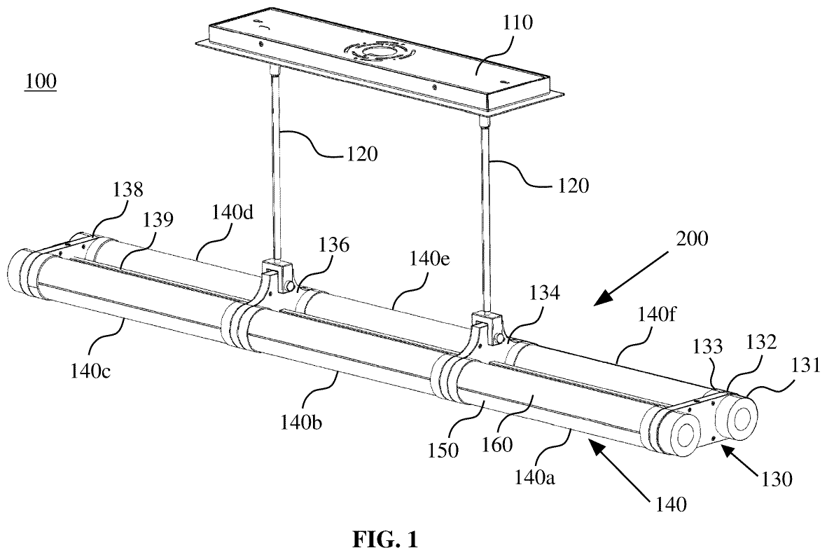

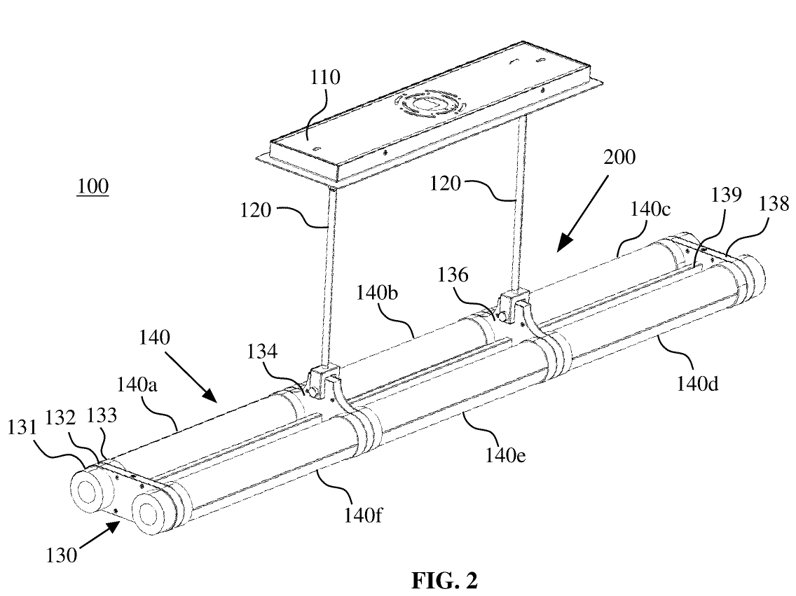

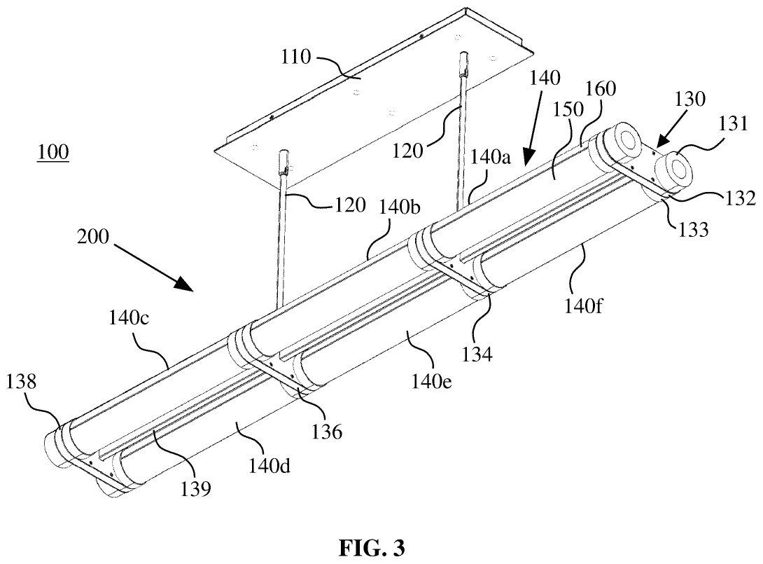

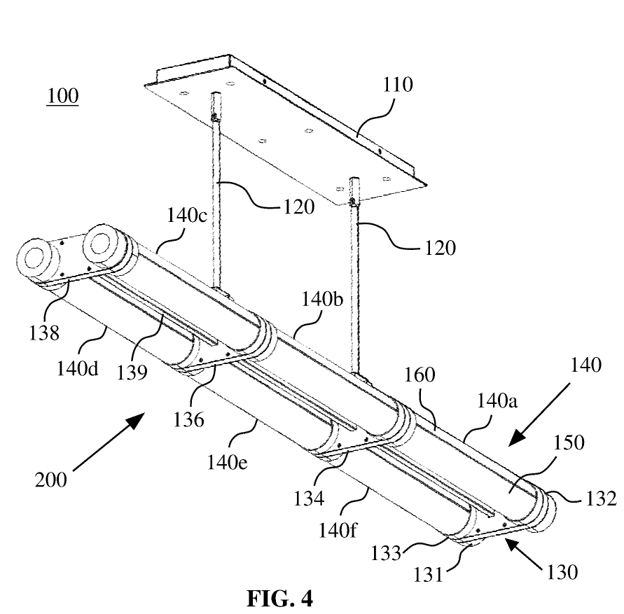

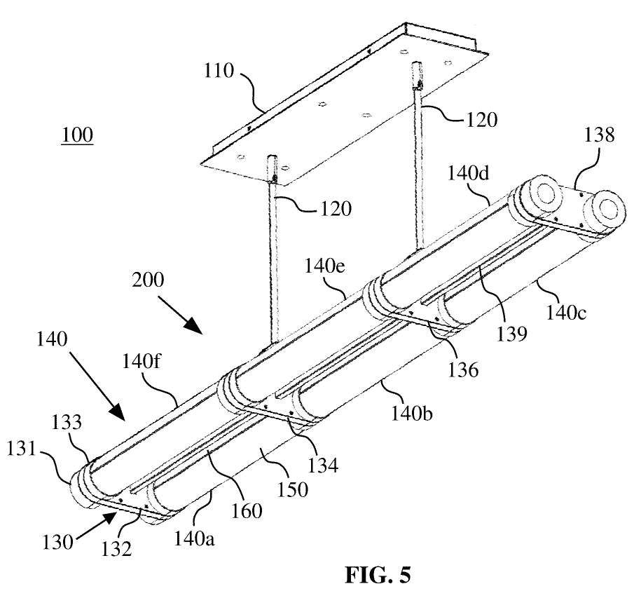

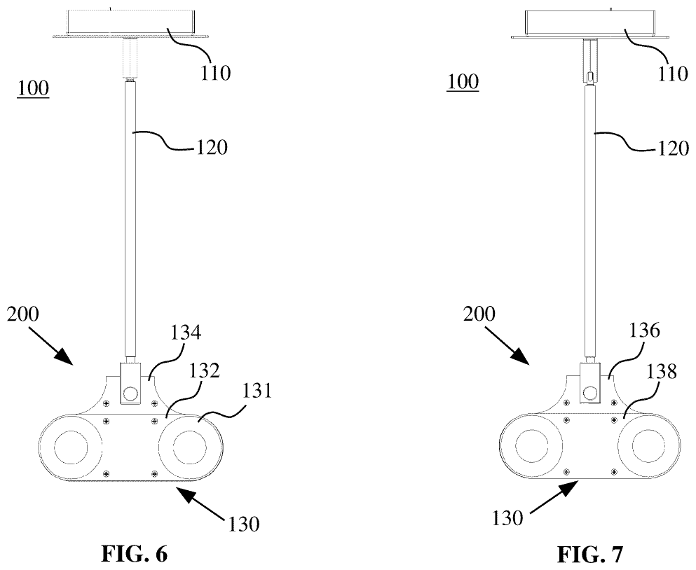

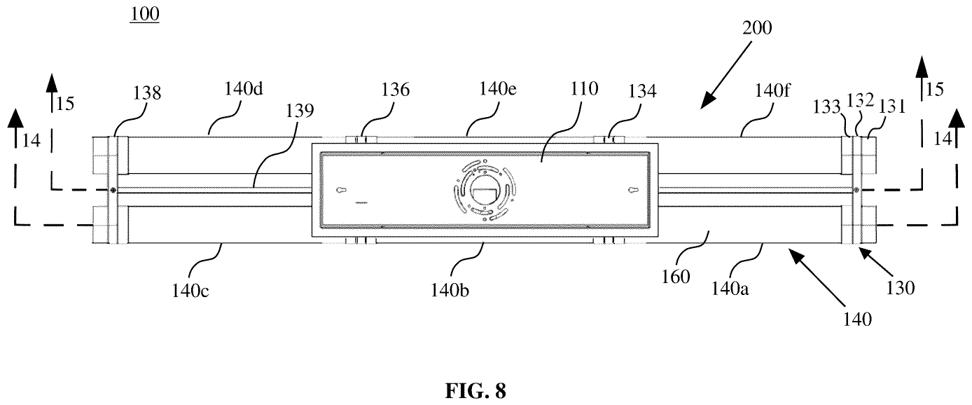

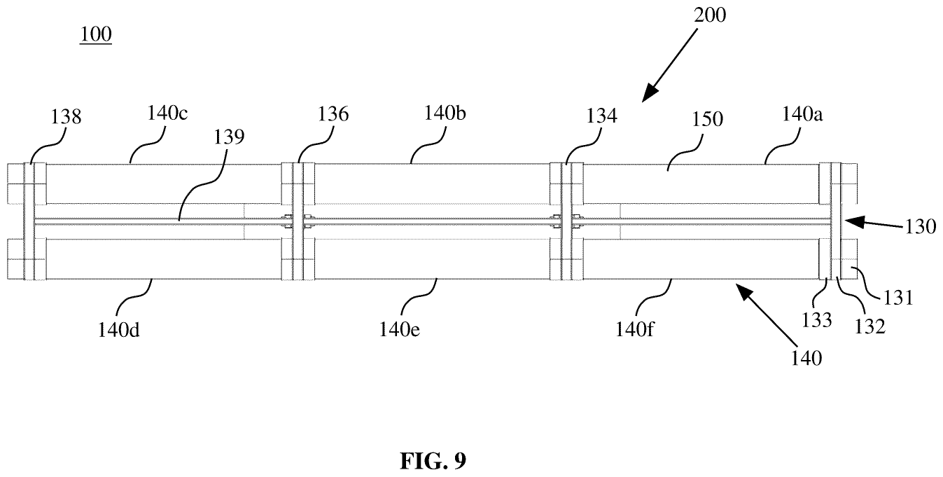

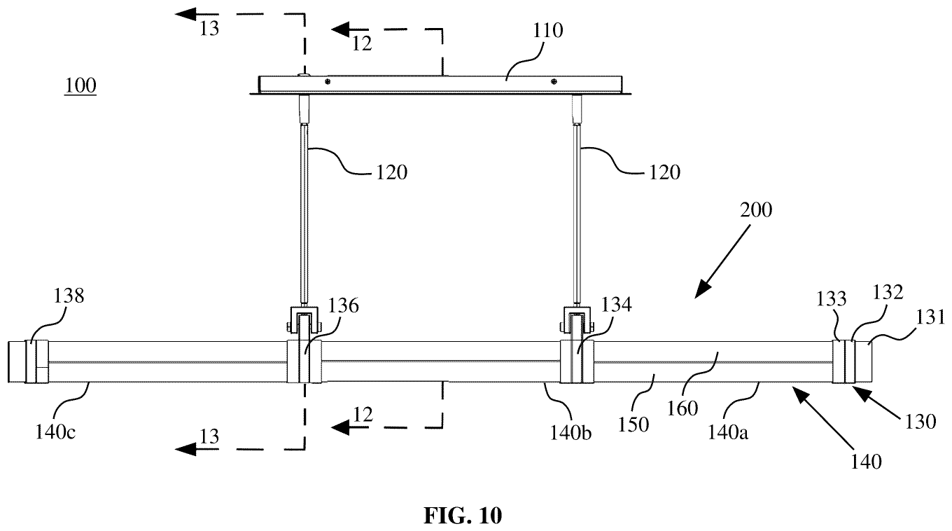

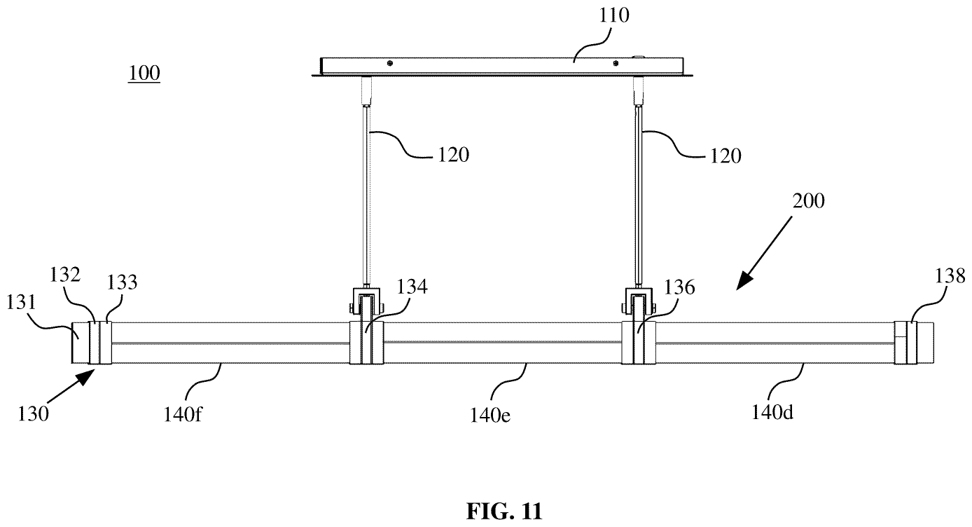

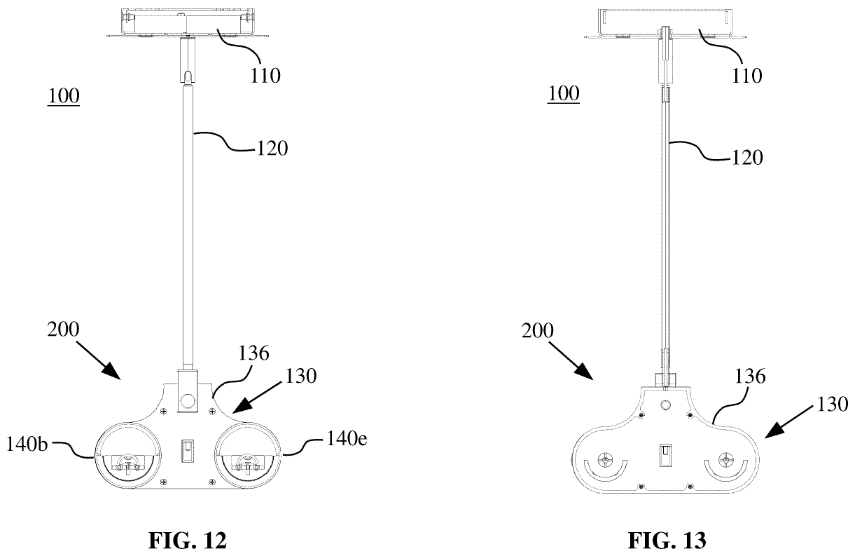

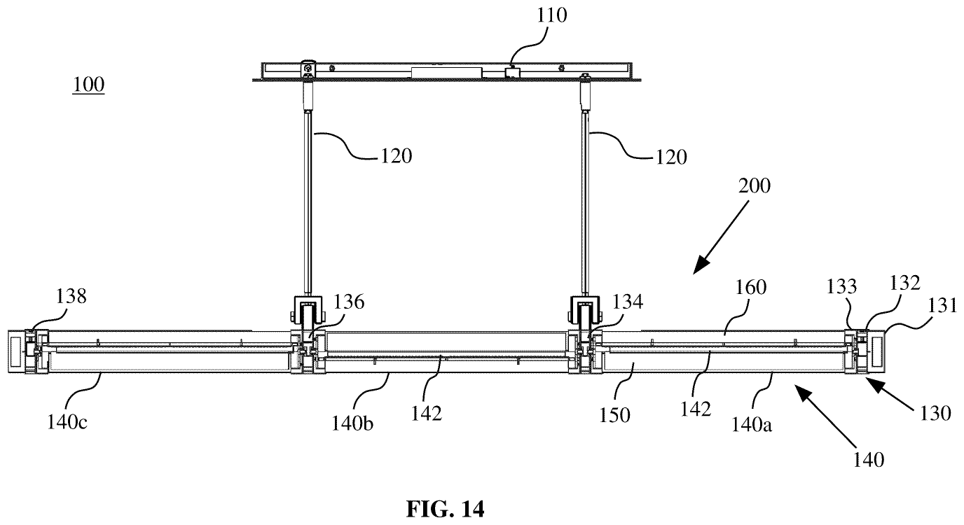

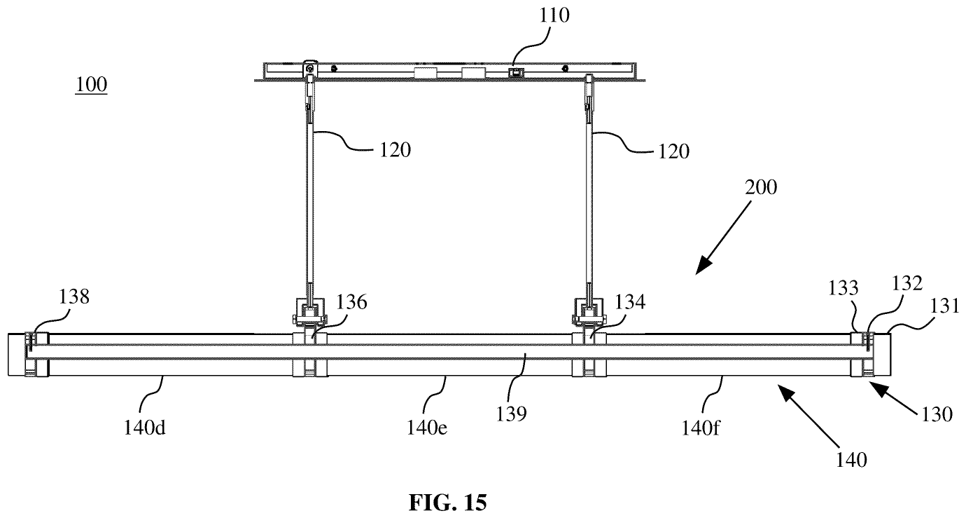

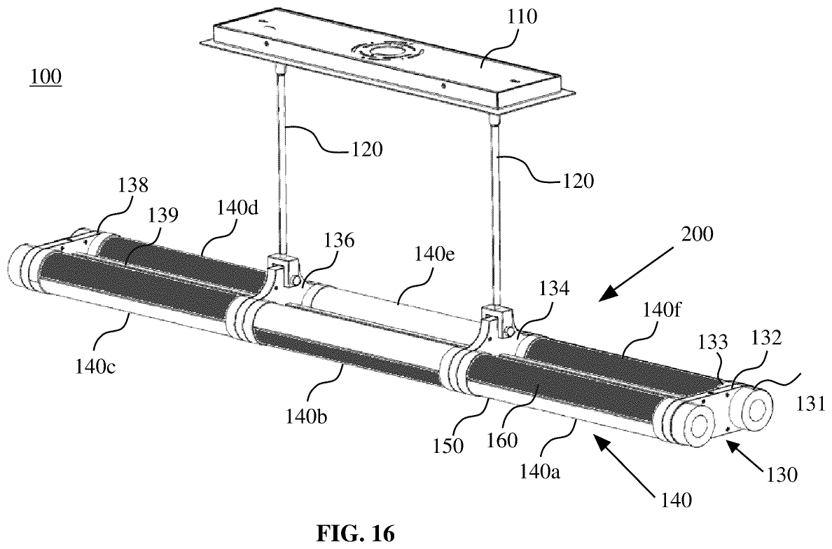

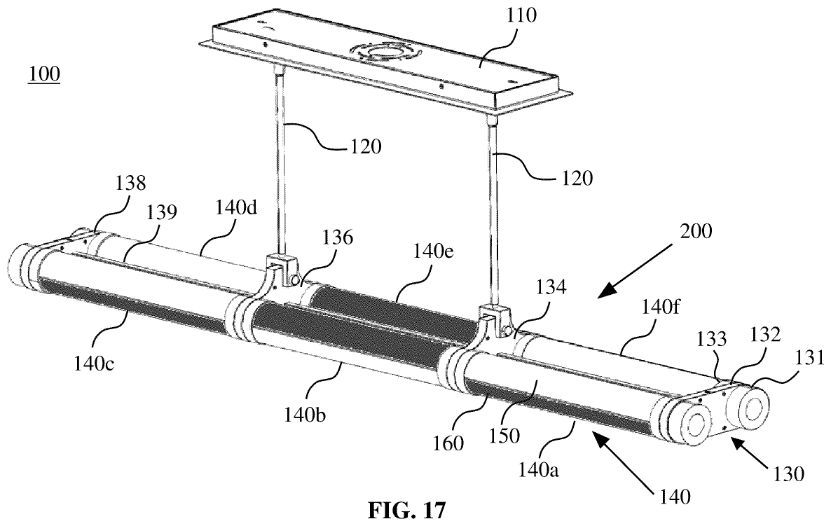

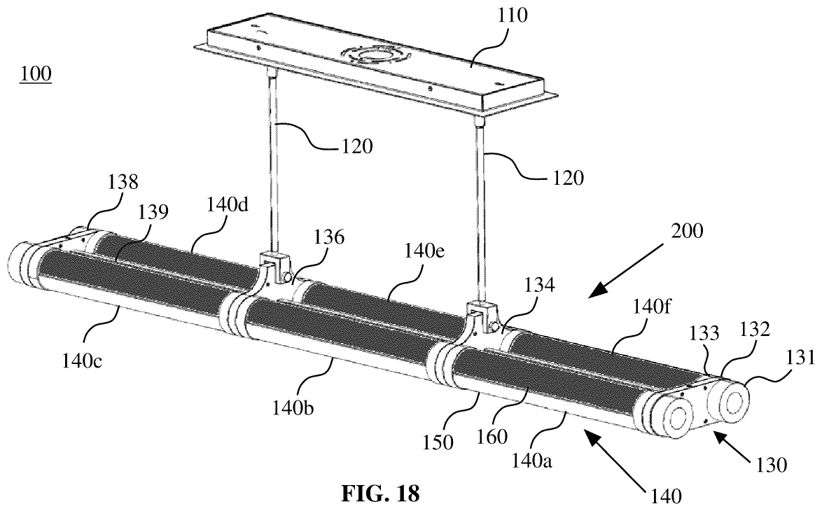

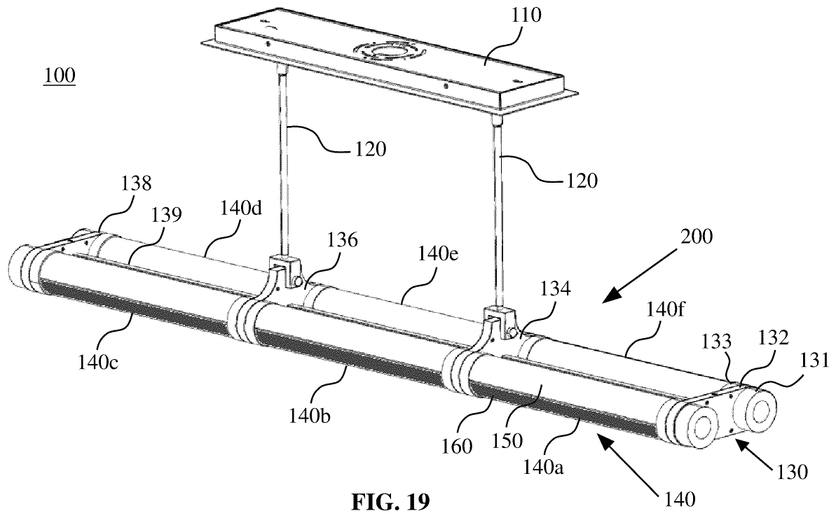

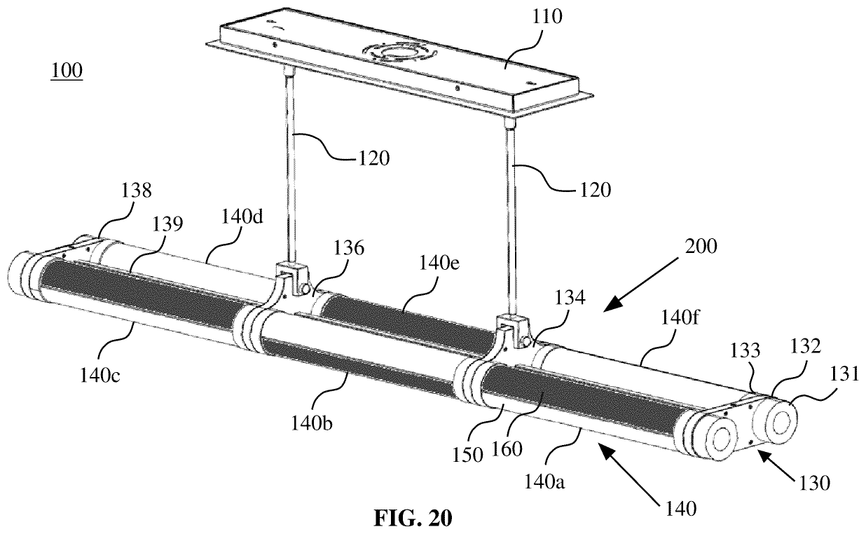

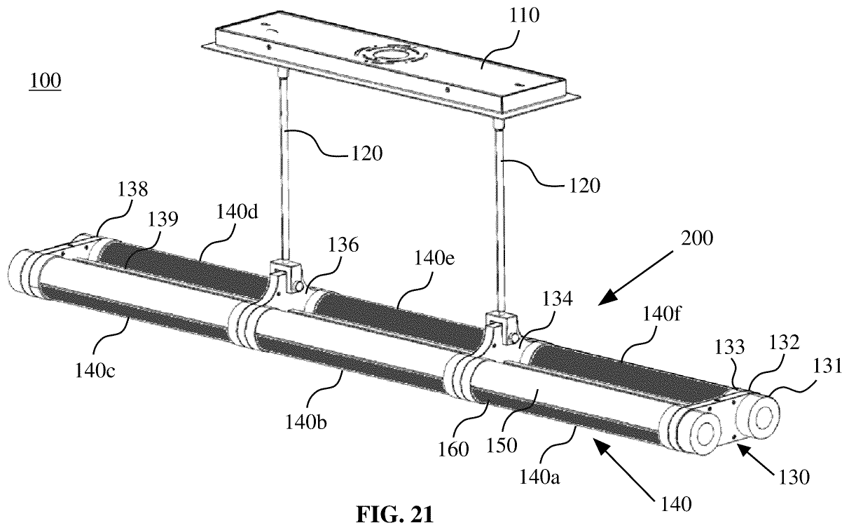

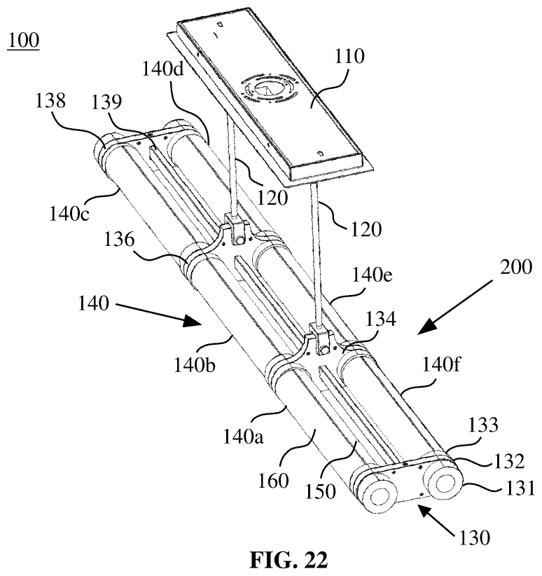

FIG. 1 illustrates one embodiment of a lighting pendant 100 in accordance with an aspect of the present disclosure. Lighting pendant 100 generally includes a ceiling mount 110, a lighting fixture 200, and one or more elements 120 supporting the lighting fixture 200 from the ceiling mount 110. The lighting pendant 100 is operably connected to an electrical power supply.

Elements 120 may be hollow elements configured to receive a wire or plurality of wires. In some embodiments, elements 120 may be a wire or a plurality of wires. Lighting pendant 100 may include one or more elements 120. In this illustrated embodiment, lighting pendant 100 includes two elements 120.

Lighting fixture 200 generally includes a frame 130 and an illuminable assembly 140 in accordance with an aspect of the present disclosure as described in greater detail below.

Frame 130 may generally include one or more annular members and one or more support brackets. In embodiments, frame 130 may also include at least one bracing element 139. First annular member 131 and second annular member 133 may define a cavity configured to receive, or be otherwise connected to, an illuminable assembly 140 of the lighting fixture 200. In the illustrated embodiment, frame 130 includes first annular member 131, second annular member 133, first support bracket 132, second support bracket 134, third support bracket 136, fourth support bracket 138, and bracing element 139. First support bracket 132 may be disposed between first annular member 131 and second annular member 133. As shown in the illustrated embodiments, first support bracket 132 may be configured to receive or be otherwise connected to one or more illuminable assemblies 140. As best shown in FIG. 9, bracing element 139 may be disposed between a pair of parallel illuminable assemblies 140. Bracing element 139 be received in or otherwise connected to any one of support brackets 132, 134, 136, and 138. Bracing element 139 may connect support brackets 132, 134, 136, and 138. Although support brackets 132, 134, 136, and 138 are shown disposed at an end of the illuminable assemblies 140, support brackets 132, 134, 136, and 138 may be disposed at a central portion of any one of the illuminable assemblies 140.

While the illustrated embodiments depict a frame 130 supporting six illuminable assemblies 140, it is understood that any components of frame 130 may be modified or omitted in accordance with further embodiments of present disclosure, including embodiments which include greater or fewer of the illuminable assemblies than those shown in the illustrated embodiments. For example, in some embodiments, the lighting fixture 200 may include only one illuminable assembly, and frame 130 may include two first annular members 131 and two second annular members 133, and one support element 132. In said embodiment, frame 130 does not include bracing element 139. Similarly, in embodiments wherein the illuminable assemblies 140 are disposed coaxially, wherein the lighting fixture does not include one or more illuminable assemblies 140 disposed parallel to the first illuminable assembly 140a, the frame 130 does not include bracing element 139.

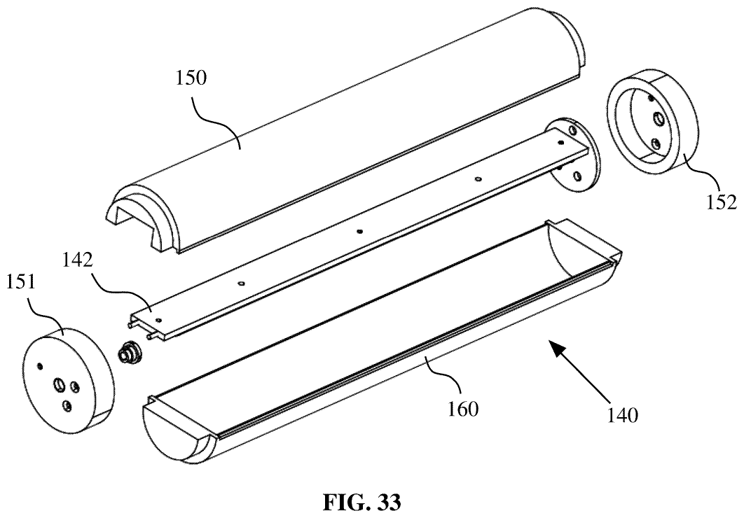

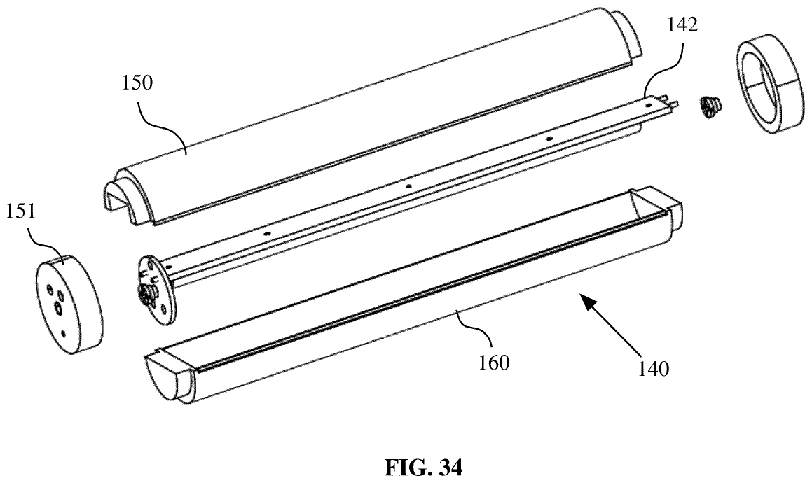

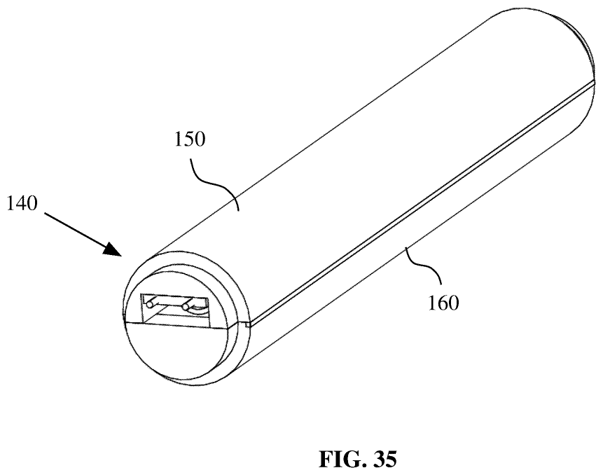

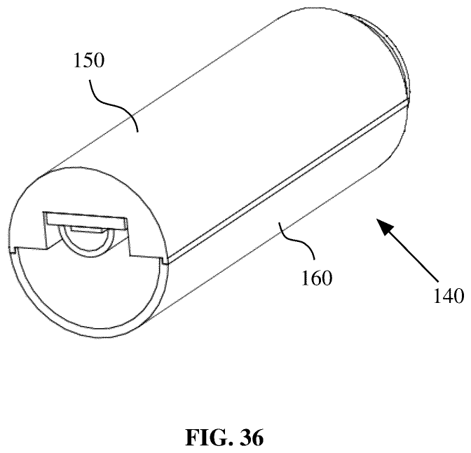

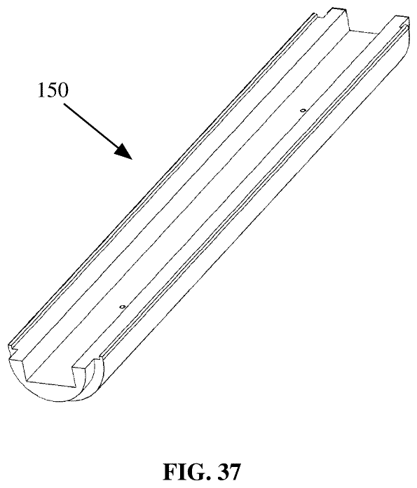

Illuminable assembly 140 generally includes a first portion 150 and a second portion 160. In embodiments, and as shown in FIG. 33, the first portion 150 includes a generally arcuate cross-section and the second portion 160 includes a generally arcuate cross-section. The first portion 150 may be formed from a translucent or transparent material. The second portion 160 may be formed from an opaque or non-translucent material. In some embodiments, the second portion 160 includes black stone. While the second portion 160 is shown opaque or non-translucent in FIG. 16, the entire second portion need not be opaque or non-translucent. Likewise, although the first portion 150 is depicted as translucent in the illustrated examples, the entire first portion 150 need not be translucent or transparent.

Illuminable assembly 140 may include a light source, such as an LED strip 142, as best shown in FIG. 33. In addition, other light sources may be suitably employed. For example, incandescent or fluorescent light sources may be employed.

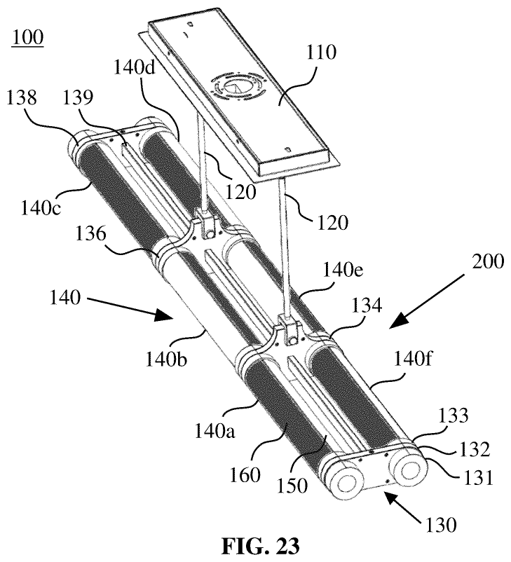

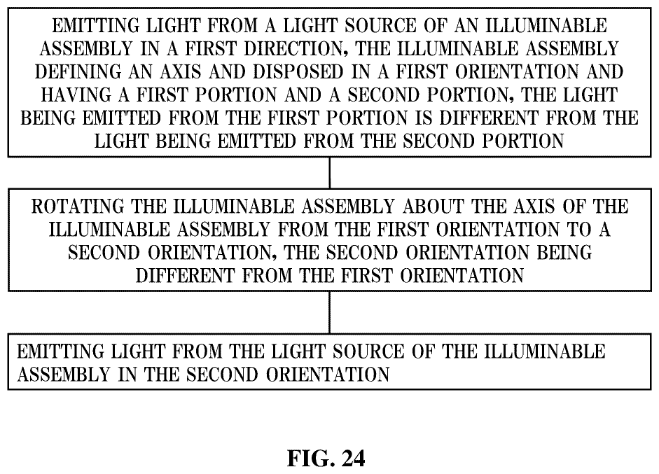

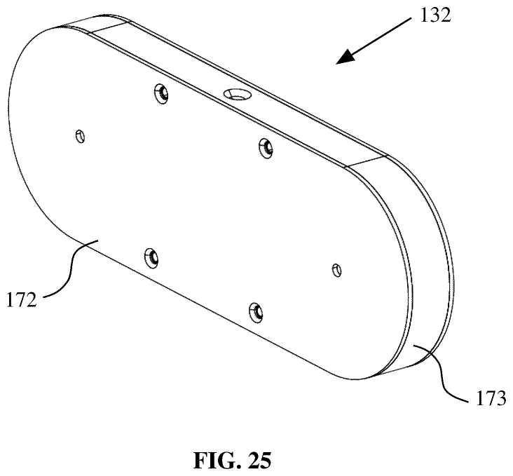

As shown best in FIGS. 16 and 23, the illuminable assembly 140 may be operably rotatably coupled to the frame 130. Each illuminable assembly 140 defines a longitudinal axis and is coupled to the frame 130 such that illuminable assembly 140 can rotate about its longitudinal axis. Rotation of the illuminable assembly 140 may be 360 degrees. In embodiments, rotation of illuminable assembly 140 may be limited to less than 360 degrees. In embodiments, rotation of illuminable assembly 140 may be limited to 180 degrees. Rotation of the illuminable assembly 140 may be clockwise or counterclockwise. The illuminable assembly 140 may rotate to transition the illuminable assembly 140 from a first position to a second position. In the first position, the first portion 150 of illuminable assembly 140 may be disposed in a downward orientation, and the second portion 160 of illuminable assembly 140 may be disposed in an upward orientation. In the second position of the illuminable assembly 140, the first portion 150 may be disposed in an upward orientation, and the second portion 160 may be disposed in a downward orientation. In embodiments, the second position may be achieved by rotating the illuminable assembly 140 180 degrees from first position. Although the illustrated examples depict various non-limiting possible orientations of the illuminable assembly 140, it is appreciated that illuminable assembly 140 can be positioned at any degree of rotation about its longitudinal axis not explicitly shown or discussed herein. Thus, each illuminable assembly 140 can rotate in a clockwise or counterclockwise direction about its longitudinal axis 0 to 360 degrees, or greater than 360 degrees.

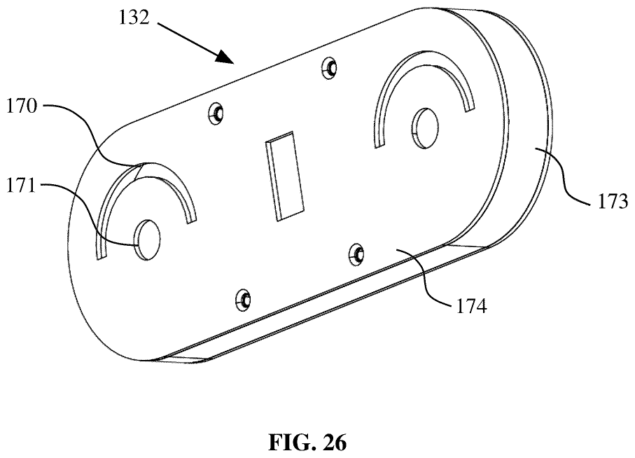

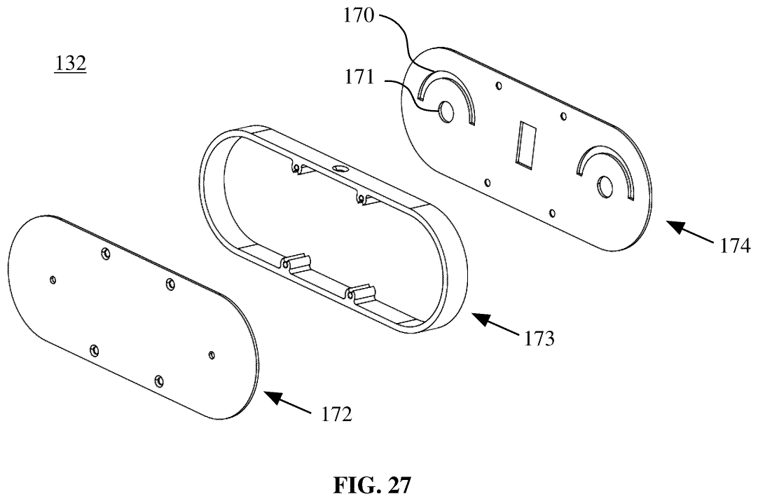

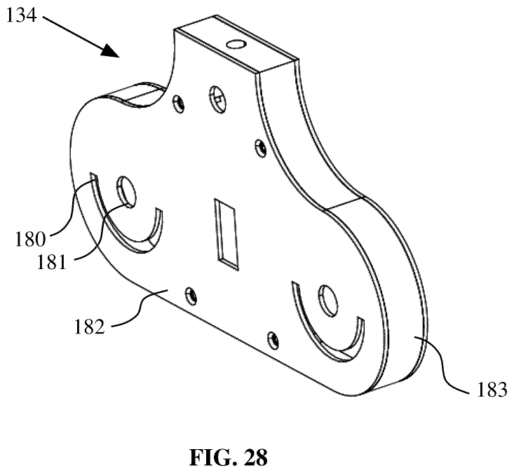

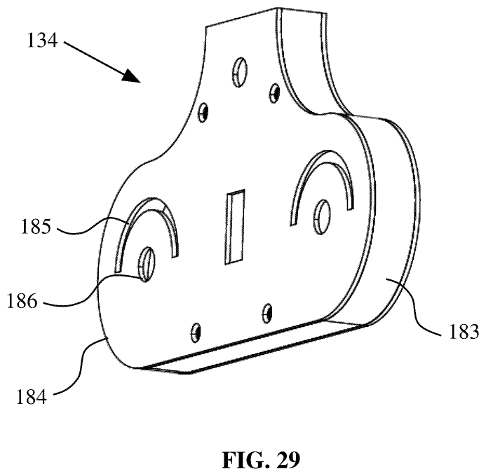

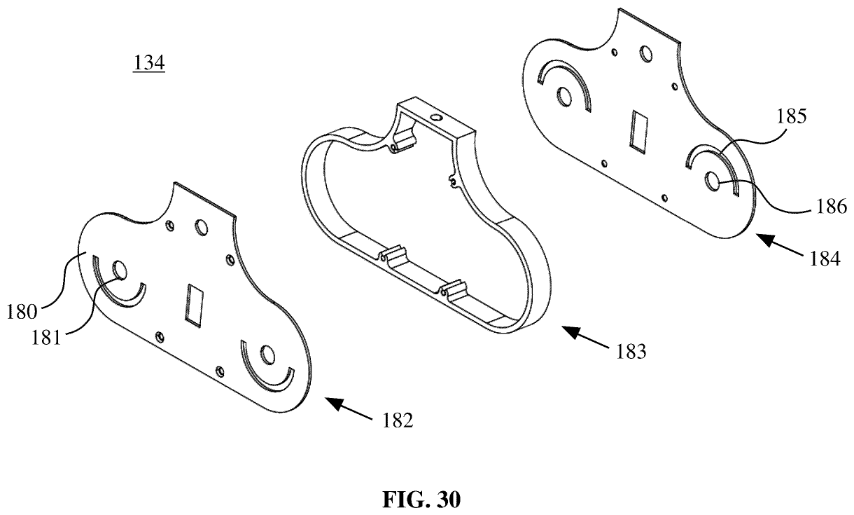

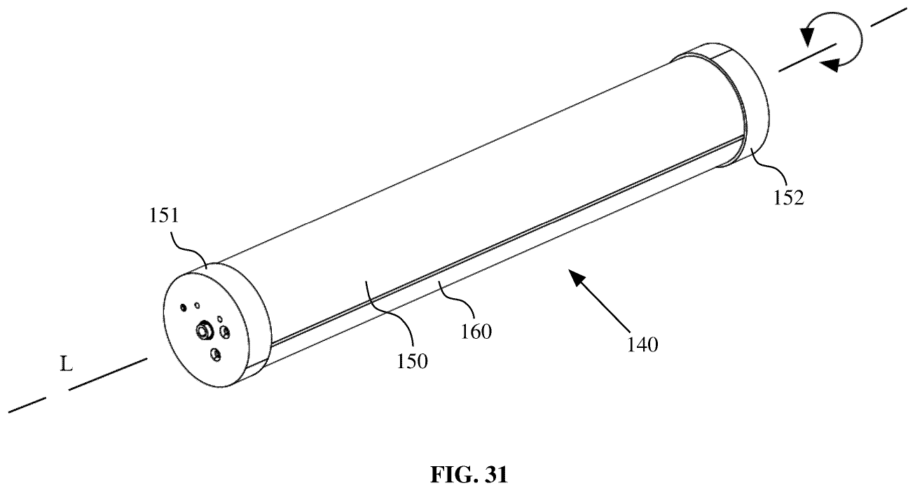

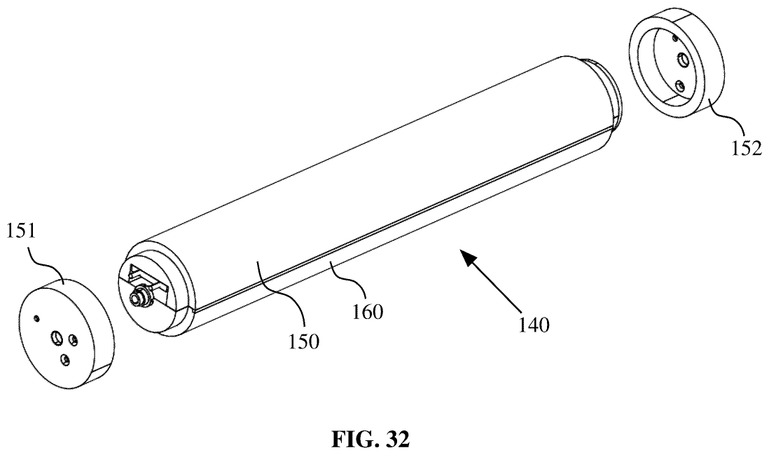

With reference to FIGS. 26, 28, and 31, illuminable assembly 140 may include a pin (not shown) at the end thereof that is received in arcuate cutouts 170 and 180 (FIGS. 26 and 28, respectively) that limits the rotation of illuminable assembly 140 to about 180 degrees. Such a configuration may prevent or inhibit the electrical wires to the light source from becoming twisted and/or damaged during use of the lighting fixture. In other embodiments, the rotation may be limited to more or less than 360 degrees.

In alternative embodiments, the second portion 160 of the illuminable assembly 140 may be configured to rotate around the first portion 150, which may be fixed.

Illuminable assembly 140 may have a generally cylindrical configuration as shown in FIG. 1, or may have any other suitable configuration such as rectangular prism, triangular prism, elliptic cylinder, or various polyhedron configurations, and combinations thereof. For example, the planar configuration (i.e., cross-section) of the illuminable assembly may be triangular, circular, ovular, square, rectangular, or various other polygonal configurations. Although illuminable assembly 140 is shown as having a uniform shape in the illustrated examples, each illuminable assembly 140 may have a non-uniform shape.

The lighting fixture 200 may include one or more illuminable assemblies 140. In some embodiments, the lighting fixture 200 includes one illuminable assembly. In further embodiments, the lighting fixture 200 may include two or more illuminable assemblies 140. In embodiments where lighting fixture 200 includes two or more illuminable assemblies 140, the first illuminable assembly 140a may be disposed coaxially to the second illuminable assembly 140b. In further embodiments, the first illuminable assembly 140a may be disposed parallel to the second illuminable assembly 140b. It is appreciated that illuminable assemblies 140 may be disposed in other suitable configurations. For example, illuminable assemblies 140 may be disposed such that the longitudinal axis a first illuminable assembly 140a may be disposed perpendicular to the longitudinal axis of a second illuminable assembly 140b. Furthermore, the longitudinal axis of each illuminable assembly 140 may extend radially for a connection point.

As depicted in the illustrated examples, the lighting fixture 200 may include six illuminable assemblies 140, a first illuminable assembly 140a, a second illuminable assembly 140b, a third illuminable assembly 140c, a fourth illuminable assembly 140d, a fifth illuminable assembly 140e, and sixth illuminable assembly 140f. In this illustrated embodiment, first illuminable assembly 140a, third illuminable assembly 140b, fourth illuminable assembly 140d, and sixth illuminable assembly 140f are disposed in the first position, wherein second illuminable assembly 140b and a fifth illuminable assembly 140e are disposed the second position. Thus, each individual illuminable assembly 140 can rotate separately and independently from the other illuminable assemblies 140, allowing for a multitude of different configurations of the lighting fixture 200.

While the illustrated embodiment depicts the illuminable assemblies 140 as comprising a first portion 150 and second portion 160, it is contemplated that the illuminable assembly may include further portions. For example, illuminable assembly 140 may include first portion 150, second portion 160, and one or more further portions. The one or more further portions may be the same as one of the first portion 150 or second portion 160, or different from both the first portion 150 and second portion 160. The one or more further portions portion may be opaque, non-translucent, or translucent. When two or more further portions are included, the further portions may be the same or different from each other.

Each illuminable assembly 140, first portion 150, and second portion 160 have a surface area. In the illustrated embodiments, the surface area of first portion 150 and the surface area of second portion 160 each include half the total surface area of the illuminable assembly 140. However, in other embodiments, the first portion 150 may include more or less than half of the total surface area of the illuminable assembly 140. Likewise, in further embodiments, the second portion 160 may include more or less than half of the total surface area of the illuminable assembly 140.

In embodiments of the present disclosure which include two or more illuminable assemblies 140, the first portions 150 and second portions 160 of each illuminable assembly 140 may be the same or different. For example, if lighting fixture 200 includes a first illuminable assembly 140a and second illuminable assembly 140b, the first portion 150 of the first illuminable assembly 140a may include different materials than that of the first portion 150 of the second illuminable assembly 140b. In embodiments, each illuminable assembly 140 of the lighting fixture 200 need not be identical in material, shape, or configuration.

Although the illustrated examples depict the lighting fixture 200 disposed horizontally, it is appreciated that the lighting fixture may be disposed vertically, or at any angle.

In embodiments of the present disclosure may include a lighting pendant 100, as shown in the illustrated embodiments. Alternative embodiments of the present disclosure, by way of non-limiting examples, may include a flush mount, a wall sconce, a floor or table lamp comprising the lighting fixture 200 described in detail herein.

Thus, while various non-limiting embodiments of the present disclosure have been illustrated and described herein, it will be appreciated to those skilled in the art that various modifications, additions, substitutions, and the like can be made without departing from the spirit of the present disclosure and these are therefore considered to be within the scope of the present disclosure as defined in the claims that follow.

1. A lighting fixture, comprising:
a frame; and
a first illuminable assembly rotatably supportable by the frame, the first illuminable assembly having a first end, a second end, and first axis extending from the first end to the second end, the first illuminable assembly comprising
a first portion extending from the first end of the first illuminable assembly to the second end of the first illuminable assembly,
a second portion extending from the first end of the first illuminable assembly to the second end of the of the first illuminable assembly, the first portion being different from the second portion, and
a light source disposable between the first portion and the second portion;
the first illuminable assembly being rotatable about the first axis between:
a first orientation of the first portion and the second portion, and
a second orientation of the first portion and the second portion, wherein the second orientation is different from the first orientation of the first portion and the second portion.

2. The lighting fixture of claim 1, wherein the first portion is translucent and the second portion is opaque.

3. The lighting fixture of claim 1, wherein the first portion is translucent and the second portion comprises a black stone.

4. The lighting fixture of claim 1, wherein the first illuminable assembly is limited to rotation of 180 degrees with respect to the first axis of the first illuminable assembly.

5. The lighting fixture of claim 1, wherein the first illuminable assembly comprises a first end cap and a second end cap, and ends of the first portion and the second portions are receivable end the first and second end caps.

6. The lighting fixture of claim 1, wherein the first illuminable assembly is rotatable clockwise or counterclockwise with respect to the first axis of the first illuminable assembly.

7. The lighting fixture of claim 1, wherein the first axis is horizontally disposed.

8. The lighting fixture of claim 1, wherein the first orientation of the first illuminable assembly comprises the first portion disposed in a downward orientation, and the second position disposed in an upward orientation.

9. The lighting fixture of claim 1, wherein the second orientation of the first illuminable assembly comprises the first portion disposed in an upward orientation, and the second position disposed in a downward orientation.

10. The lighting fixture of claim 1, wherein the first illuminable assembly comprises an outer surface, wherein the first portion comprises one-half of the outer surface of the first illuminable assembly, and the second portion comprises one-half of the outer surface of the first illuminable assembly.

11. The lighting fixture of claim 1, wherein the first portion and the second portion defines a cylinder disposed between the first end and the second end of the first illuminable assembly.

12. The lighting fixture of claim 1, wherein the second portion comprises an arcuate cross-section.

13. The lighting fixture of claim 1, wherein the first illuminable assembly receives a light emitting diode (LED).

14. The lighting fixture of claim 1, comprising
a second illuminable assembly, wherein the second illuminable assembly defines a second axis, wherein the second axis is disposed parallel to the first axis, wherein the first illuminable assembly and second illuminable assembly are connectable via the frame.

15. The lighting fixture of claim 1, comprising
a second illuminable assembly, wherein the second illuminable assembly defines a second axis, wherein the second axis is disposed coaxially aligned with the first axis, wherein the first illuminable assembly and second illuminable assembly are connectable via the frame.

16. The lighting fixture of claim 1, comprising
a second illuminable assembly, wherein the second illuminable assembly defines a second axis, wherein the second axis is disposed coaxially aligned with the first axis, wherein the first illuminable assembly and second illuminable assembly are connectable via the frame; and
a third illuminable assembly, wherein the third illuminable assembly defines a third axis, wherein the third axis is disposed coaxially aligned with the first and second axis, wherein the second illuminable assembly and third illuminable assembly are connectable via the frame.

17. The lighting fixture of claim 1, comprising
a second illuminable assembly, wherein the second illuminable assembly defines a second axis, wherein the second axis is disposed coaxially aligned with the first axis, wherein the first illuminable assembly and second illuminable assembly are connectable via the frame;
a third illuminable assembly, wherein the third illuminable assembly defines a third axis, wherein the third axis is disposed parallel to the first axis, wherein the third illuminable assembly is connectable to the first illuminable assembly and second illuminable assembly via the frame; and
a fourth illuminable assembly, wherein the fourth illuminable assembly defines a fourth axis, wherein the fourth axis is disposed coaxially to the third axis and parallel to the first and second axis, wherein the further illuminable assembly is connectable to the first illuminable assembly, second illuminable assembly, and third illuminable assembly via the frame.

18. The lighting fixture of claim 1, comprising
a second illuminable assembly, wherein the second illuminable assembly defines a second axis, wherein the second longitudinal axis is disposed coaxially to the first axis, wherein the first illuminable assembly and second illuminable assembly are connectable via the frame;
a third illuminable assembly, wherein the third illuminable assembly defines a third axis, wherein the third axis is disposed parallel to the first axis, wherein the third illuminable assembly is connectable to the first illuminable assembly and second illuminable assembly via the frame;
a fourth illuminable assembly, wherein the fourth illuminable assembly defines a fourth axis, wherein the fourth longitudinal axis is disposed coaxially to the third axis and parallel to the first and second axis, wherein the fourth illuminable assembly is connectable to the first illuminable assembly, second illuminable assembly, and third illuminable assembly via the frame;
a fifth illuminable assembly, wherein the fifth illuminable assembly defines a fifth axis, wherein the fifth axis is disposed coaxially to the first and second axis and parallel to the third and fourth axis, wherein the fifth illuminable assembly is connectable to the second illuminable assembly and fourth illuminable assembly via the frame; and
a sixth illuminable assembly, wherein the sixth illuminable assembly defines a sixth axis, wherein the sixth axis is disposed coaxially to the third and fourth axis and parallel to the first, second, and fifth axis, wherein the sixth illuminable assembly is connectable to the second illuminable assembly, fourth illuminable assembly, and fifth illuminable assembly via the frame.

19. A method for providing illumination, the method comprising,
emitting light from a light source of an illuminable assembly in a first direction, the illuminable assembly defining an axis and disposed in a first orientation and having a first portion and a second portion, the light being emitted from the first portion is different from the light being emitted from the second portion;
rotating the illuminable assembly about the axis of the illuminable assembly from the first orientation to a second orientation, the second orientation being different from the first orientation;
emitting light from the light source of the illuminable assembly in the second orientation.

20. The method of claim 20, further comprising
emitting light from a light source of a second illuminable assembly in a third orientation, the second illuminable assembly defining a second axis and disposed in a first orientation and having a third portion and a fourth portion, the light being emitted from the third portion is different from the light being emitted from the fourth portion;
rotating the second illuminable assembly about a second longitudinal axis of the second illuminable assembly;
emitting light from the light source in a fourth orientation.
